(19) United States
(12) Patent Application Publication
(10) Pub. No.: US 2024/0281873 A1
(43) Pub. Date: Aug. 22, 2024

(54) ROSCA AUTOMATIC BID RENEWAL METHOD AND ITS SERVO DEVICE

(71) Applicant: Godmiracle International Network Co., Ltd., Taichung (TW)

(72) Inventor: Chien-An Chen, Taichung (TW)

(21) Appl. No.: 18/172,331

(22) Filed: Feb. 22, 2023

(51) Int. Cl. G06Q 30/08

(52) U.S. Cl. CPC G06Q 30/08

(57) ABSTRACT

A ROSCA (Rotating Savings and Credit Association) automatic bid renewal method implemented by a servo device storing at least one bid information, comprising (A) receiving a command containing member information to be added, determining whether the target bid information includes at least one bid information; (B) adding the member information to be added to the corresponding ROSCA; (C) determining whether the number of members indicated is equal to the limited number; (D) periodically obtaining at least one winning member information from the target bid information; (E) generating and transmitting a transfer instruction to the financial platform containing the winning member account and the winning bid; (F) confirming whether the winning member renews the bid; and (G) upon receiving the bid renewal instruction, using the winning member information as the member information to be added, and using the bidding renewal instruction as the bidding command, and returning to Step (A).

### STATEMENT REGARDING PRIOR DISCLOSURES BY AN INVENTOR OR JOINT INVENTOR

The contents of Taiwanese Patent Application No. 110210738 filed on Sep. 10, 2021 and published on Mar. 21, 2022, is a grace period disclosure and shall not be prior art to claimed invention.

### FIELD OF THE INVENTION

The present invention relates to financial electronic commerce, more particularly, a ROSCA automatic bid renewal method and its servo device.

### BACKGROUND OF THE INVENTION

The ROSCA (Rotating Savings and Credit Association) is a local and common financial lending method in Taiwan, and with the development of e-commerce, there are many online ROSCA systems that combine this kind of local ROSCA with the Internet, however, the user member of the current online ROSCA systems, if he/she wants to continue to invest the winning bid in other ROSCAs to gain the profit, he/she needs to choose the new ROSCA to invest by his/her own after winning the bid and receiving the winning bid, this not only wastes the time that the winning bid could not be used as soon as possible but also makes it impossible to gain the profit, greatly reduces the efficiency of the online ROSCA system and affects the interests of all user members participating in the online ROSCA system.

### SUMMARY OF THE INVENTION

Therefore, the purpose of the present invention is to provide an automatic bid renewal method and its servo device which can automatically renew the bid by the winning bid and improve the efficiency of the subsequent use of the winning bid.

The ROSCA automatic bid renewal method, which is implemented by a servo device connecting a plurality of operation ends and a financial platform via a communication network and storing at least one corresponding bid information, and each bid information includes at least one member information indicated by the corresponding ROSCA, and the ROSCA automatic bid renewal method comprises Steps of (A) to (G).
Step (A), after receiving a bidding command from any of the operation ends including the member information to be added, determines by the servo device whether at least one bid information includes the target bid information indicating that the corresponding membership number is less than the limited number.
Step (B), when the target bid information is determined to include, updating at least one member information of the target bid information by the servo device based on the member information to be added so that the member corresponding to the member information to be added can be added to the ROSCA corresponding to the target bid information.
Step (C), when the target bid information is updated, uses the servo device to determine whether the number of members indicated by the target bid information is equal to the maximum number of members.
Step (D), when the number of members indicated by the target bid information is determined to be equal to the maximum number of members, periodically, by means of the servo device, from the member information in the target bid information to obtain at least one winning member information.
Step (E), for each winning member information, a transfer instruction containing a winning member account and a winning bid corresponding to the winning member information is generated by the servo device and transmitted to the financial platform.
Step (F), for each winning member information, generating and transmitting a renewal confirmation by the servo device whether the member renews the bid to a target operation end corresponding to the winning member information.
Step (G), by means of the servo device, after receiving a renewal instruction corresponding to the renewal confirmation from the target operation end, uses the winning member information as the member information to be added, and uses the bid renewal instruction as the bidding command, and returns to Step (A).

The automatic bid renewal servo device of the present invention connects a plurality of operation ends and a financial platform through a communication network. The automatic bid renewal servo device contains a server communication module, a server storage module, and a server processing module. The server communication module is connected to the communication network. The server storage module individually stores the bid information corresponding to at least one ROSCA, and each bid information contains at least one member information indicating the member of the corresponding ROSCA. The server processing module is electrically connected to the server communication module and the server storage module. Wherein, after the server processing module receives a bidding command from any operation end via the server communication module containing member information to be added, determines whether at least one bid information includes the target bid information indicating the corresponding membership number is smaller than the limited number, and when the server processing module determines that it includes the target bid information, the server processing module will update at least one member information of the target bid information based on the member information to be added, so that the member corresponding to the member information to be added can be added to the ROSCA corresponding to the target bid information, when the server processing module determines that the target bid information is updated, the server processing module will determine whether the number of members indicated by the target bid information is equal to the maximum number of members, and when the server processing module determines that the number of members indicated by the target bid information is equal to the maximum number of members, the server processing module will periodically obtain at least one winning member information from the member information in the target bid information, for each winning member information, the server processing module will generate a transfer instruction containing one of the account information and a winning bid of the winning member information and transmit the transfer instruction via the server communication module to the financial platform, for each winning member information, the server processing module will generate a renewal confirmation whether the member renews the bid, and the server processing module will transmit the renewal confirmation to a target operation end corresponding to the winning member information, and for each winning member information, after the server processing module receives a renewal instruction corresponding to the renewal confirmation from the target operation end via the server communication, uses the winning member information as the member information to be added, and uses the bid renewal instruction as the bidding order, so that the member corresponding to the member information to be added can be added to the ROSCA corresponding to the target bid information.

The effect of the present invention is that: the servo device generates and transmits the renewal confirmation for confirming whether the member renews the bid to the target operation end corresponding to the member information, and after receiving the renewal instruction corresponding to the renewal confirmation from the target operation end, sets the winning member and invests the winning bid in a new ROSCA, so that the winning member does not need to spend extra time searching for the new ROSCA to be invested in which could effectively use the winning bid obtained by the winning member.

### BRIEF DESCRIPTION OF THE DRAWINGS

Other features and effects of the present invention will be clearly presented with reference to the embodiments of the drawings, wherein:

FIG. 1 is a block diagram illustrating an embodiment of an implementation of the automatic bid renewal system of one of the automatic bid renewal methods of the present invention;

FIG. 2 is a flowchart illustrating Steps 61 to 66 of the automatic bid renewal method of the present embodiment;

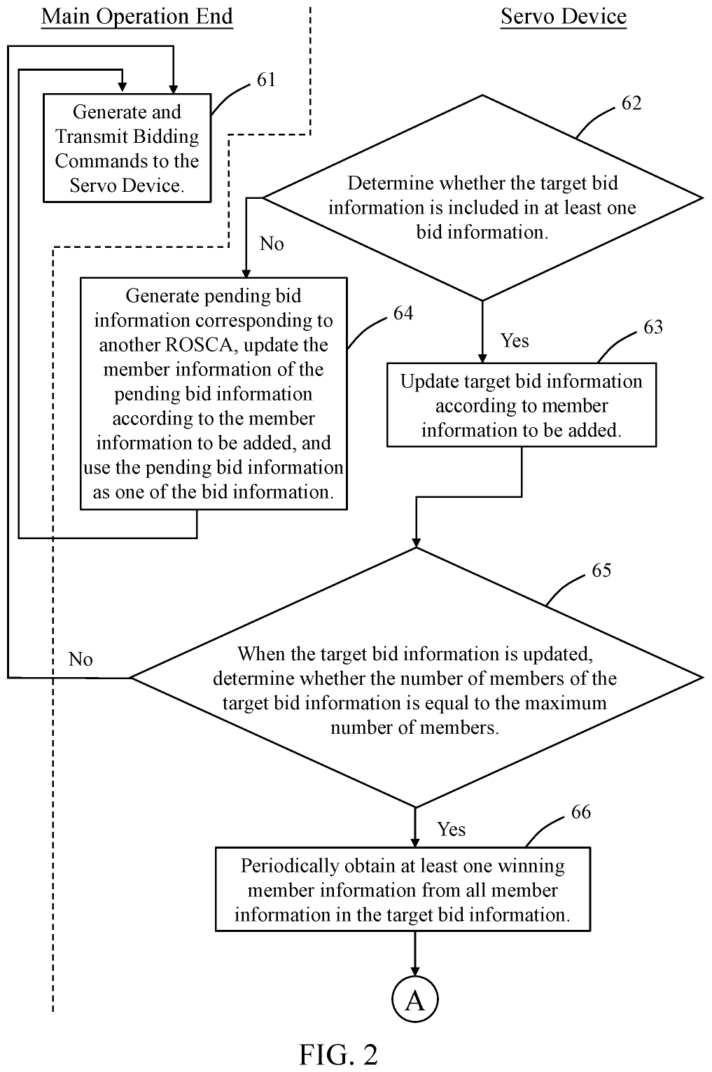

FIG. 3 is a flowchart illustrating Steps 67 to 72 of the automatic bid renewal method of the present embodiment;

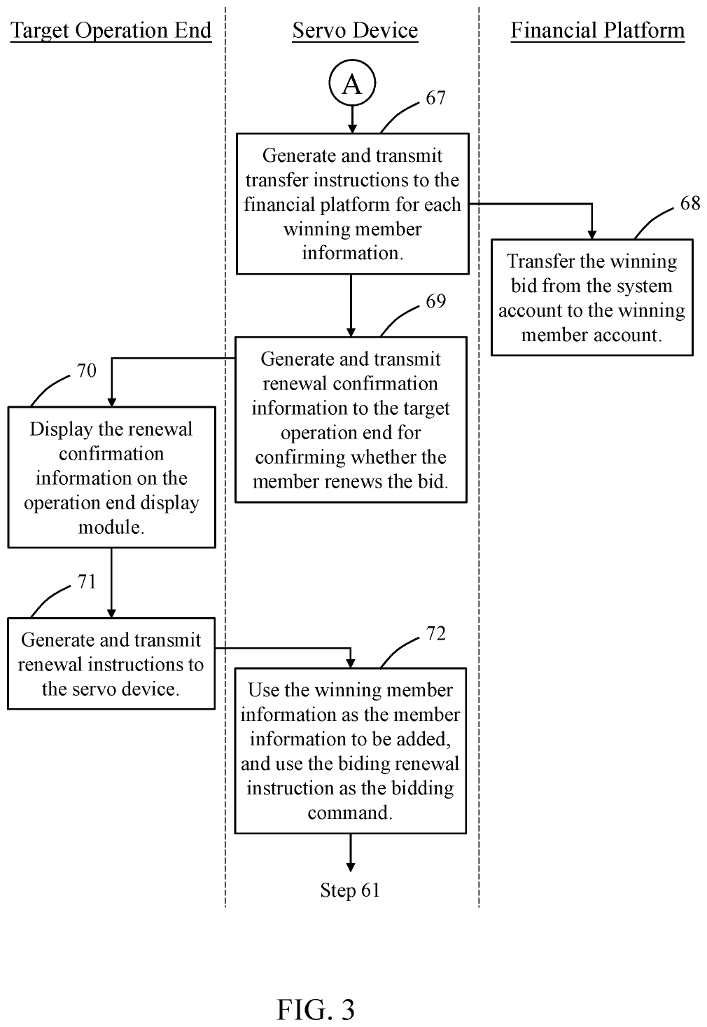

FIG. 4 is a flowchart illustrating Step 66 of the automatic bid renewal method of the present embodiment further comprising Steps A661 to A663;

FIG. 5 is a flowchart illustrating Step 66 of the automatic bid renewal method of the present embodiment further comprising Steps B661 to B663;

FIG. 6 is a flowchart illustrating Step B662 of the automatic bid renewal method of the present embodiment further comprising Steps A662-1 to A662-3; and

FIG. 7 is a flowchart illustrating Step 66 of the automatic bid renewal method of the present embodiment further comprising Steps C661 to C665.

### DESCRIPTION OF THE PREFERRED EMBODIMENTS

Before the present invention is described in detail, it should be noted that in the following description, similar components are denoted by the same number.

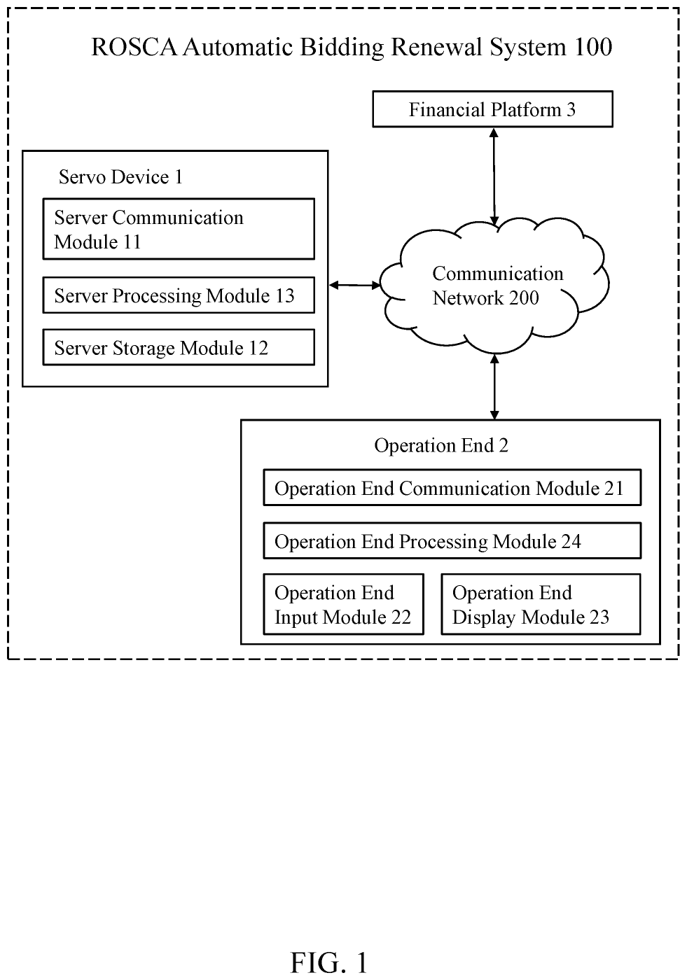

Referring to FIG. 1, an embodiment of an automatic bid renewal system 100 for implementing one of the automatic bid renewal methods of the present invention comprises an automatic bid renewal servo device 1 (hereinafter referred to as: servo device 1), a plurality of operation ends 2 respectively connected to the servo device 1 via a communication network 200, and a financial platform 3 connected to the servo device 1 via the communication network 200.

The servo device 1 includes a server communication module 11 connected to the communication network 200, a server storage module 12, and a server processing module 13 electrically connected to the server communication module 11 and the server storage module 12.

The server storage module 12 stores at least one bid information corresponding to at least one ROSCA and a system account used in the financial platform 3.
wherein each bid information includes at least one member information indicating the corresponding member of the ROSCA, a membership limit indicating the limited number of the member corresponding to the ROSCA, a bid winning limit (i.e., the number of bid) indicating the limited number of times each member corresponding to the ROSCA may bid, an initial winning bid, a first initial bid fee, a second initial bid fee, a bid winning level increment, and a bid fee level increment. In particular, each member's information includes a member account, a member number, and basic member information used on the financial platform (e.g., name, age, occupation, income, etc.).

Each operation end 2 comprises an operation end communication module 21 connected to the communication network 200, an operation end input module 22, an operation end display module 23, and an operation end processing module 24 electrically connected to the operation end communication module 21, the operation end input module 22, and the operation end display module 23.

In this embodiment, the embodiment of the servo device 1 is, for example, a personal computer, a server, or a cloud host, but not limited thereto. The embodiment of the operation end 2 is, for example, a personal computer, a server, or a cloud host, but not limited thereto. The embodiment of the financial platform 3 is, for example, a banking system, but not limited thereto.

Referring to FIGS. 1˜7 is one of the embodiments that the automatic bid renewal system 100 implements the automatic bid renewal method of the present invention, and the automatic bid renewal method comprises Steps 61˜72.

Referring to FIGS. 1˜3, in Step 61, the operation end processing module 24 of the main operation end 2 generates a bidding command containing member information to be added based on the input signal generated by the operation end input module 22 operated by the user of the corresponding main operation end 2, and transmits the bidding command to the servo device 1 via the operation end communication module 21. Wherein, the main operation end 2 is one of said operation ends 2.

In Step 62, after the server processing module 13 receives the bidding command from the main operation end 2 via the server communication module 11, it sets the initial value of the number of winning bids included in the member information to be added to the limited number of winning bids, and determines whether the target bid information indicating that the number of members of the corresponding ROSCA is less than the corresponding maximum number of members is included in the at least one bid information stored in the server storage module 12. If the server processing module 13 determines that the target bid information is included in at least one bid information, the process proceeds to Step 63; and if the server processing module 13 determines that the target bid information is not included in at least one bid information, the process proceeds to Step 64.

In Step 63, the server processing module 13 updates at least one member information of the target bid information according to the member information to be added, and adds the member corresponding to the member information to be added to the ROSCA corresponding to the target bid information, and implements the Step 65. In particular, in other embodiments, the bidding command may also include a bidding number indicating the corresponding ROSCA, and the server processing module 13 may also add, according to the club number, the member corresponding to the member information to the ROSCA corresponding to any target bid information specified by the bidding number.

In Step 64, the server processing module 13 generates pending bid information corresponding to another ROSCA, updates the member information of the pending bid information according to the member information to be added, and adds the member corresponding to the member information to be added to the other ROSCA, and uses the pending bid information as one of such bid information, and returns to Step 61.

In Step 65, when the target bid information is updated, the server processing module 13 determines whether the number of members indicated by the target bid information is equal to the corresponding maximum number of members. If the server processing module 13 determines that the number of members indicated by the target bid information is equal to the corresponding maximum number of members, the process proceeds to Step 66; if the server processing module 13 determines that the number of members indicated by the target bid information is less than the corresponding maximum number of members, the process returns to Step 61.

In Step 66, the server processing module 13 periodically and randomly obtains at least one winning member information from the member information in the target bid information. In particular, the periodicity described in this Step means that the servo device 1 periodically (e.g., every month) and randomly obtains at least one winning member information from the member information in the target bid information after the membership of the ROSCA corresponding to the target bid information is full until the expiration of the ROSCA corresponding to the target bid information.

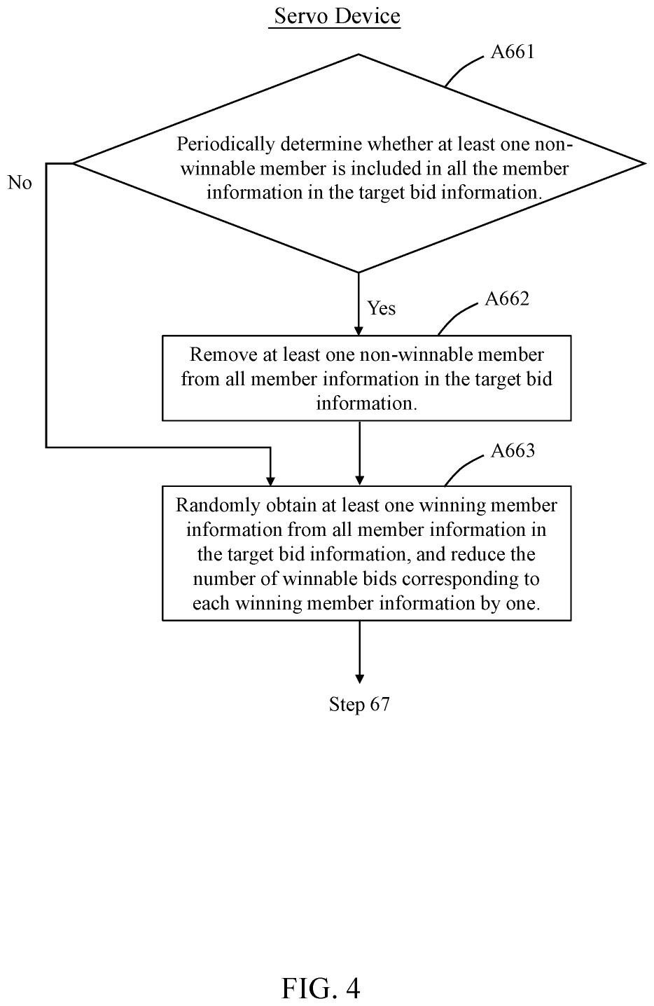

In particular, referring to FIG. 4, in the first embodiment of this embodiment, Step 66 also comprises Steps A661 to A663.

In Step A661, the server processing module 13 periodically determines whether at least one non-winnable member with zero number of winnable bids is included in the member information of the target bid information. If the server processing module 13 determines that at least one non-winnable member is included in the member information of the target bid information, the process proceeds to Step A662; and if the server processing module 13 determines that no non-winnable member is included in the member information of the target bid information, the process proceeds to Step A663.

In Step A662, the server processing module 13 removes at least one non-winnable member from the member information in the target bid information.

In Step A663, the server processing module 13 randomly obtains at least one winning member information from the member information in the target bid information and reduces the number of winnable bids corresponding to each winning member information by one.

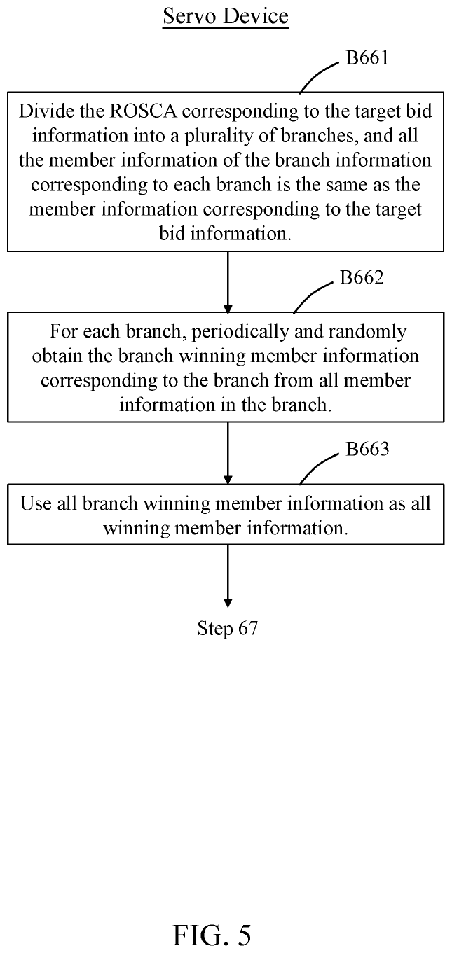

In particular, referring to FIG. 5, in the second embodiment of this embodiment, Step 66 also comprises Steps B661 to B663.

In Step B661, the server processing module 13 divides the ROSCA corresponding to the target bid information into a plurality of branches. Wherein, the member information of the branch information corresponding to each branch is the same as the member information corresponding to the target bid information.

In Step B662, for each branch, the server processing module 13 periodically and randomly obtains the branch winning member information corresponding to that branch from that branch member information.

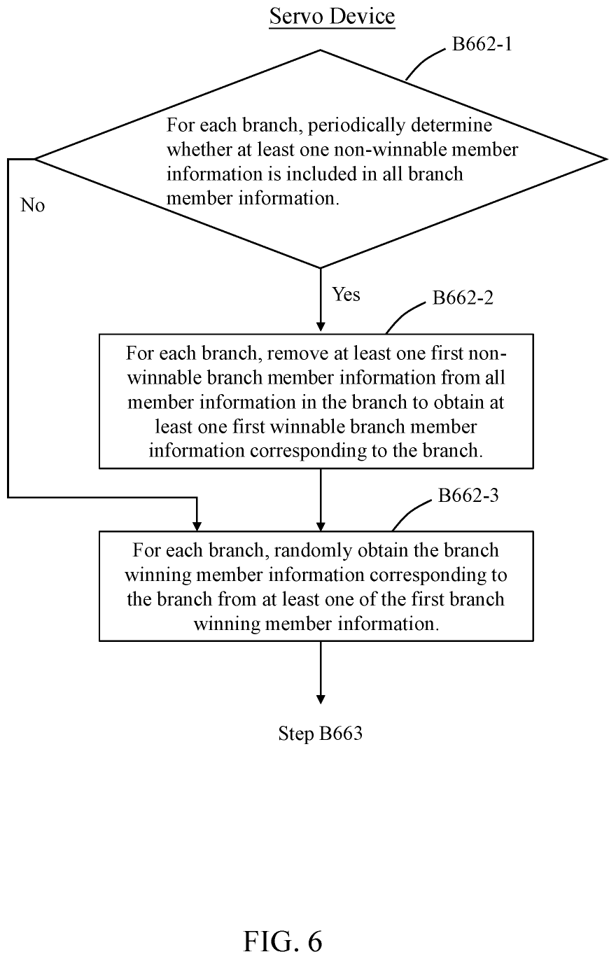

In particular, referring to FIG. 6, Step B662 also comprises Steps B662-1˜B662-3.

In Step B662-1, for each branch, the server processing module 13 periodically determines whether there is at least one first non-winnable branch member information among the member information for that branch. Wherein each first non-winnable branch member information includes a time period between a previous bid winning time and a current time that is less than a preset time period. If the server processing module 13 determines that at least one of the first non-winnable branch member information is included in the branch member information, then the process proceeds to Step B662-2; and if the server processing module 13 determines that none of the first non-winnable branch member information is included in the branch member information, then the process proceeds to Step B662-3.

It should be noted that for each branch, the previous winning time included in each member information for that branch is the closest time to the current time of at least one winning time by the branch member corresponding to that member information for at least one branch other than that branch. For example, if the current time is 2021 May 1, the preset time period is 3 months, the ROSCA starts at full capacity on 2021 January 1 and is divided into a first branch and a second branch, and member A wins the bid on dates 2021 February 1 and 2021 March 1 for the first branch, then the non-winnable branch member information for the second branch is determined to be the closest time to the current time. Therefore, in determining the non-winnable branch member information of the second branch, since the time period between the previous winning time of 2021 March 1 and the current time of 2021 May 1 of the first branch is 2 months for member A, which is less than the preset time period of 3 months, the corresponding member information of member A is considered to be one of the member information of at least a first non-winnable branch member of the second branch.

In Step B662-2, for each branch, the server processing module 13 removes at least one first non-winnable branch member information from the branch member information to obtain at least one first winnable branch member information corresponding to that branch (the at least one first non-winnable branch member information becomes the at least one first winnable branch member information after the at least one first non-winnable branch member information is removed from the branch member information)

In Step B662-3, for each branch, the server processing module 13 randomly obtains the branch winning member information corresponding to the branch from at least one first winnable branch member information of that branch.

In Step B663, the server processing module 13 uses the branch winning member information as the winning member information.

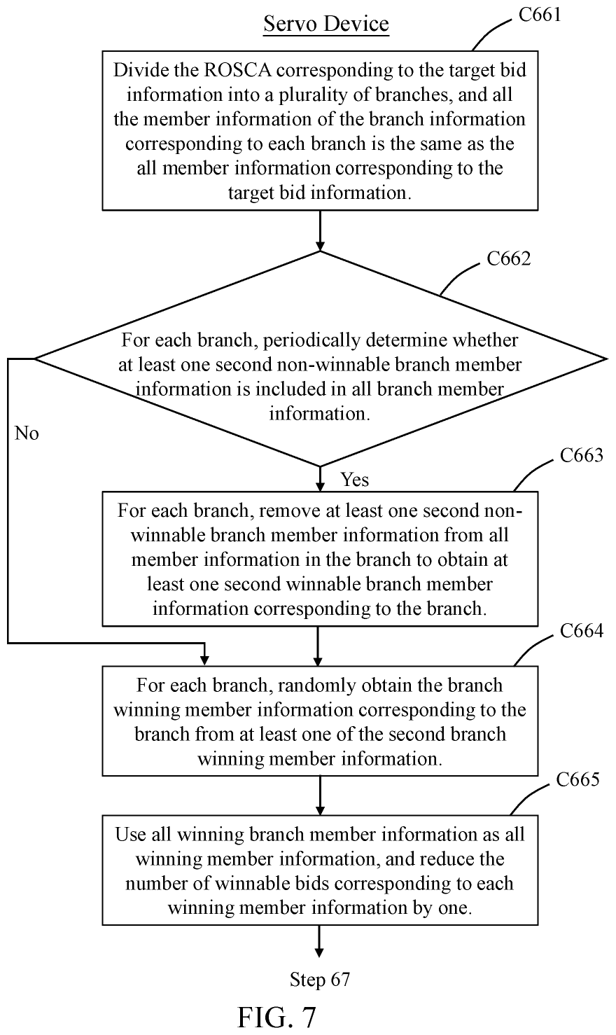

In particular, referring to FIG. 7, in other embodiments, the first embodiment and the second embodiment of Step 66 above may also be implemented simultaneously as a third embodiment, the third embodiment of Step 66 comprising Steps C661 to C665.

In Step C661, the server processing module 13 shares the target bid information corresponding to the ROSCA with each branch. Similarly, the branch member information corresponding to each branch is the same as the member information corresponding to the target bid information.

In Step C662, for each branch, the server processing module 13 periodically determines whether at least one non-winnable branch member information is included in the branch member information that is zero in bid winnable numbers or contains at least one second non-winnable branch member information that the time period between the previous bid winning time and the current time is less than the preset time period. If the server processing module 13 determines that there is at least one second non-winnable branch member information in the branch member information, the process proceeds to Step C663; and if the server processing module 13 determines that there is no second non-winnable branch member information in the branch member information, the process proceeds to Step C664.

In Step C663, for each branch, the server processing module 13 removes at least one second non-winnable branch member information from the branch member information to obtain at least one second winnable branch member information corresponding to that branch. (the at least one second non-winnable branch member information becomes the at least one second winnable branch member information after the at least one second non-winnable branch member information is removed from the branch member information).

In Step C664, for each branch, the server processing module 13 randomly obtains the branch winning member information corresponding to the branch from at least one second winnable branch member information of that branch.

In Step C665, the server processing module 13 uses the branch winning member information as the winning member information and reduces the number of the winning bids corresponding to each winning member information by one.

In Step 67, for each winning member information, the server processing module 13 generates a transfer instruction containing one of the winning member accounts and a winning bid of the winning member information, and transmits the transfer instruction to the financial platform 3 via the server communication module 11, wherein the winning member account is one of those member accounts.

In particular, for each period (periodically as described in Step 66) of at least one winning member information, the server processing module 13 calculates the winning bid and the bid fee (i.e., the bid fee to be paid to ROSCA on a regular basis) for each winning member information of the period based on the initial winning bid, the first initial bid fee, the second initial bid fee, the bid winning level increment and the bid fee level increment contained in the target bid information. For example, if the initial winning bid is 50,000, the first initial bid fee is 20,000, the second initial bid fee is 30,000, the winning level increment is 1,000 and the bid fee level increment is 1,000, then the winning bid for the first winning bid for Member A is the initial winning bid of 50,000 and the required bid fee for each subsequent period is the first initial bid fee of 20,000. The second winning bid for Member A is the initial winning bid of 50,000 plus the winning increment of 1,000, which equals 51,000, and the bid fee for each subsequent period is the initial bid fee of 20,000 plus the winning increment of 1,000, which equals 21,000. The third winning bid for Member A will be the initial winning bid of 50,000 plus the winning increment of 1000*2, which equals 52,000, and the bid fee for each subsequent period will be the initial bid fee of 20,000 plus the winning increment of 1000*2, which equals 22,000, and so on until the non-winnable Member, who is determined to have zero winning bids, is not calculated in the above manner. In addition, the amount of the bid fee required for each period for those non-winnable members will be the second initial bid fee of 30,000 until the ROSCA expires according to the target bid information.

In Step 68, after receiving the transfer instruction, the financial platform 3 transfers the winning bid from the system account to the winning member account and generates and transmits to the servo device 1 a winning bid transfer information indicating the transfer of the winning bid from the system account to the winning member account.

In Step 69, the server processing module 13 generates a renewal confirmation for confirming whether the member renews, and transmits the renewal confirmation to one of the target operation ends 2 corresponding to the member information via the server communication module 11, wherein the target operation end 2 is one of the operation ends 2.

In particular, in Step 67, the server processing module 13 may also implement Step 69 directly after transmitting the transfer instruction to the financial platform 3 via the server communication module 11.

In Step 70, the operation end processing module 24 of the target operation end 2 displays the renewal confirmation information on the operation end display module 23 after receiving the renewal confirmation via the operation end communication module 21.

In Step 71, the operation end processing module 24 of the target operation end 2 generates a renewal instruction based on an input signal generated by the user via the operation end input module 22, and transmits the renewal instruction to the servo device 1 via the operation end communication module 21.

In Step 72, after the server processing module 13 receives the renewal instruction from the target operation end 2 corresponding to the renewal confirmation via the server communication module 11, the server processing module 13 uses the winning member information as the member information to be added, and uses the renewal instruction as the bidding command, and re-executes Step 61 so that the member corresponding to the member information to be added can use the winning bid and invest it in the new ROSCA. In particular, the servo device 1 receives the renewal instruction from multiple target operation ends 2 corresponding to different targets, and then generates new multiple ROSCAs for the members to renew their bids and investments.

In summary, the ROSCA automatic bid renewal method of the present invention confirms whether the winning member renews the bid by means of the server processing module 13, and if the winning member confirms the renewal, the winning member and the winning bid are entered into the new ROSCA so that the winning bid can be used quickly and effectively in the first time and the benefits of the winning member can be continuously expanded. In addition, it is periodically determined whether there is at least one non-winnable member information in each branch which contains a time period between the previous bid winning time and the current time which is less than the preset time period, and removing at least one non-winnable member information from the branch member information, reduces the risk of malicious fraud by members who have continuously won bids within a short period of time. Thus, the purpose of the invention is effectively achieved.

However, the above are only the embodiments of the present invention, which cannot be used to limit the scope of the implementation of the present invention, and all simple equivalent changes and modifications made according to the claims and patent specification of the present invention are still covered within the scope of the present invention.

What is claimed is:

1. A ROSCA automatic bid renewal method, implemented by a servo device connecting a plurality of operation ends and a financial platform via a communication network; the servo device storing at least one corresponding bid information, and each bid information including at least one member information indicated by a corresponding ROSCA, and the ROSCA automatic bid renewal method comprising the Steps of:
(A) determining, by means of the servo device, after receiving a bidding command from any of the operation ends including the member information to be added, whether at least one bid information includes a target bid information indicating that the corresponding member number is less than the limited number;
(B) when it is determined that the target bid information is included, updating at least one member information of the target bid information based on the member information to be added by means of the servo device, so that the member corresponding to the member information to be added can be added to the ROSCA corresponding to the target bid information;
(C) when the target bid information is updated, determining by the servo device whether the number of members indicated by the target bid information is equal to the maximum number of members;
(D) when the number of members indicated by the target bid information is determined to be equal to the maximum number of members, periodically obtaining at least one winning member information from the member information in the target bid information by means of the servo device;
(E) for each winning member information, generating by means of the servo device and transmitting to the financial platform a transfer instruction including a winning member account and a winning bid corresponding to the winning member information;
(F) for each winning member information, generating and transmitting, by means of the servo device, a renewal confirmation as to whether the member renews the bid to a target operation end corresponding to the winning member information; and
(G) after receiving a renewal instruction corresponding to the renewal confirmation from the target operation end, using, by means of the servo device, the winning member information as the member information to be added, and using the bid renewal instruction as the bidding order, and returning to Step (A).

2. The ROSCA automatic bid renewal method according to claim 1, wherein after Step (A), the following step is also included:
(H) when it is determined that the target bid information is not included, generating pending bid information corresponding to another ROSCA by the servo device, updating the member information of the pending bid information in accordance with the member information to be added, and adding the member corresponding to the member information to be added to the other ROSCA, and using the pending bid information as one of such bid information.

3. The ROSCA automatic bid renewal method according to claim 1, wherein each bid information also includes a limited number of winning bids, wherein,
in Step (B), setting the winnable initial value of the number of winning bids contained in the member information to be added to the limited number of winning bids by the servo device;
Step (D) includes the following Steps:
(D-1) when it is determined that the number of members indicated by the target bid information is equal to the maximum number, periodically determining whether there is at least one corresponding non-winnable member containing a zero number of winnable bids for the member information of the target bid information by the servo device;
(D-2) if it is determined that there is at least one non-winnable member in the member information of the target bid information, removing at least one non-winnable member from the member information of the target bid information by the servo device; and
(D-3) obtaining at least one winnable member from the member information of the target bid information by the servo device and reducing the corresponding winnable number of each winnable member information by one.

4. The ROSCA automatic bid renewal method according to claim 1, wherein Step (D) comprises the following Steps:
(D-1) when it is determined that the number of members indicated by the target bid information is equal to the maximum number, dividing the ROSCA corresponding to the target bid information into plural branches by the servo device, and the member information of one of the branch information corresponding to each branch is the same as the member information corresponding to the target bid information;
(D-2) for each branch, periodically obtaining the branch winning member information corresponding to the branch from the member information of the branch by means of the servo device; and
(D-3) using, by means of the servo device, the branch winning member information as the winning member information.

5. The ROSCA automatic bid renewal method according to claim 1, wherein Step (D-2) comprises the following Steps:
(D-2-1) for each branch, periodically determining by the servo device whether there is at least one non-winnable branch member information in the member information of the branch, each non-winnable branch member information including a time period between a previous bid winning time and a current time that is less than a preset time period;
(D-2-2) for each branch, when it is determined that at least one non-winnable branch member information is included in the member information of the branch, removing at least one non-winnable branch member information from the member information of the branch by means of the servo device to obtain the corresponding at least one winnable branch member information of the branch; and
(D-2-3) for each branch, obtaining the corresponding branch winning member information of the branch from at least one branch winnable member information of branch by means of the servo device.

6. A ROSCA automatic bid renewal servo device, connected to multiple operation ends and a financial platform via a communication network, comprising:
a server communication module, connected to the communication network;
a server storage module, storing at least one ROSCA information corresponding to at least one ROSCA, each ROSCA information including at least one member information indicating the member of the corresponding ROSCA; and
a server processing module, electrically connected to the server communication module and the server storage module;
wherein, after the server processing module receives a bidding command from either operation end containing member information to be added via the server communication module, the server processing module determines whether there is target bid information by at least one bid information indicating that the number of members of the corresponding ROSCA is less than a maximum number of members, and if the server processing module determines that the target bid information includes, then the server processing module updates at least one member information of the target bid information in accordance with the member information to be added so that the member corresponding to the member information to be added is added to the ROSCA corresponding to the target bid information, when the server processing module determines that the target bid information is updated, and the server processing module determines whether the number of members indicated in the target bid information is equal to the maximum number of members, when it determines that the number of members indicated in the target bid information is equal to the maximum number of members, the server processing module periodically obtains at least one winning member information from the member information of the target bid information, and for each winning member information, the server processing module generates a transfer instruction including account information of the winning member information and a winning bid, and transmits the transfer instruction to the financial platform via the communication module; for each winning member information, the server processing module generates renewal confirmation information for confirming whether the member renews the bid, and transmits the renewal confirmation to one of the target operation ends corresponding to the winning member information via the server communication module; for each winning member information, after the server processing module receives a renewal instruction from the target operation end corresponding to the renewal confirmation via the server communication module, uses the winning member information as the member information to be added, and uses the renewal instruction as the bidding command to add the member information to be added to the ROSCA corresponding to the other target bid information.

7. The ROSCA automatic bid renewal servo device according to claim 6, wherein, when the target bid information is determined not to be included, the server processing module generates a pending bid information corresponding to another ROSCA, updates the member information of the pending bid information in accordance with the member information to be added, and adds the member corresponding to the member information to be added to the other ROSCA, and uses the pending bid information as one of the bid information.

8. The ROSCA automatic bid renewal servo device according to claim 6, each bid information also contains a limited number of winning bids, wherein, the servo processing module sets the initial value of the winnable number for the member information to be added to the limited number of winning bids, and when it is determined that the number of members indicated by the target bid information is equal to the maximum number of members, the servo processing module periodically determines whether there is at least one non-winnable member with zero number of winnable bids for the member information of the target bid information, if it is determined that there is at least one non-winnable member in the member information of the target bid information, the server processing module removes the non-winnable member from the member information in the target bid information, and the server processing module obtains at least one winning member information from the member information in the target bid information, and the number of winning bids corresponding to each winning member information is reduced by one.

9. The ROSCA automatic bid renewal servo device according to claim 6, wherein, when it is determined that the number of members indicated by the target bid information is equal to the maximum number of members, the server processing module divides the ROSCA corresponding to the target bid information into a plurality of branches, and the member information of the branch information corresponding to each branch is the same as the member information corresponding to the target bid information, and for each branch, the server processing module periodically obtains the branch winning member information of the corresponding branch from the member information of that branch, and the server processing module uses the branch winning member information as the winning member information.

10. The ROSCA automatic bid renewal servo device according to claim 9, wherein, for each branch, the server processing module periodically determines whether there is at least one non-winnable branch member information among the member information for that branch, and each first non-winnable branch member information includes a time period between a previous bid winning time and a current time that is less than a preset time period; for each branch, if the at least one non-winnable branch member information is determined to be included in the branch member information, the server processing module removes at least one non-winnable branch member information from the branch member information to obtain at least one winnable branch member information corresponding to that branch; for each branch, the server processing module obtains the branch winning member information corresponding to that branch from at least one winnable branch member information of that branch.
